(19) United States
(12) Patent Application Publication
(10) Pub. No.: US 2012/0243462 A1
(43) Pub. Date: Sep. 27, 2012

(54) TRANSMISSION IN A COMMUNICATION SYSTEM USING RELAY NODES

(75) Inventors: Paul BUCKNELL, Brighton (GB); Zhaojun LI, Guildford Surrey (GB)

(73) Assignee: FUJITSU LIMITED, Kawasaki-shi (JP)

(21) Appl. No.: 13/491,951

(22) Filed: Jun. 8, 2012

Related U.S. Application Data
(63) Continuation of application No. PCT/GB2009/002941, filed on Dec. 22, 2009.

(51) Int. Cl. H04W 76/02; H04W 88/04; H04W 88/08; H04W 72/04

(52) U.S. Cl. 370/315

(57) ABSTRACT

The application relates to a transmission method in a communication system comprising a base station, a relay node and a plurality of UEs, the method comprising: when a new user data stream is established between a UE and the relay node, sending data stream characteristics including quality of service requirements, a channel identification and a UE identification for the user data stream to the base station; for transmission between the relay node and the base station, grouping the user data stream into one of a plurality of groups of multiplexed user data streams, each of which groups is defined by quality of service requirements; wherein the user data stream can be distinguished within its group on receipt using multiplexing information held within the group in conjunction with the data stream characteristics.

This is a continuation of International Patent Application No. PCT/GB2009/002941, filed on Dec. 22, 2009, now pending, the contents of which are herein wholly incorporated by reference.

The present invention relates to the field of telecommunications, and in particular to transmission techniques used between a relay node and a base station. The invention may be used in communications systems operating according to OFDMA systems such as those used in WiMAX; Universal Mobile Telecommunications System (UMTS); Code Division Multiple Access (CDMA) protocols; the GSM EDGE Radio Access Network (GERAN); or other telecommunications protocols. Specifically, the invention may be used in telecommunications protocols in which relay stations relay uplink and/or downlink user data (as opposed to control data) between a base station and a user equipment.

This invention can be applied in mobile or fixed communication system and in particular, to a method of transmitting and receiving data using relay nodes (RNs) where RNs provide essentially the same functionality as conventional base stations but the link to the network is provided using the same radio interface or other transmission resource as used by the mobile devices that connect directly to the base station.

One particular application is in UMTS, also known as 3G. UMTS wireless communication systems are being deployed worldwide. Future development of UMTS systems is centred on the so-called evolved UMTS terrestrial radio access network (evolved UTRAN or eUTRAN), more commonly referred to by the project name LTE.

LTE is a technology for the delivery of high speed data services with increased data rates for the users. Compared to UMTS and previous generations of mobile communications standards, LTE will also offer reduced delays, increased cell edge coverage, reduced cost per bit, flexible spectrum usage and multi-radio access technology mobility.

LTE has been designed to give peak data rates in the downlink (DL) direction, communication away from a base station (BS) towards a user equipment of >100 Mbps, whilst in the uplink (UL) direction, communication away from the user equipment towards the BS, of >50 Mbps.

LTE-Advanced (LTE-A), which is a development currently being standardized, will further improve the LTE system to allow up to 1 GBps in the downlink and 500 Mbps in the uplink. LTE-A will use new techniques to improve the performance over existing LTE systems, particular for the transmission of higher data rates and improvements to cell edge coverage.

LTE-Advanced and LTE share a common basic architecture and network protocol architecture. As in current UMTS systems, the basic architecture proposed for LTE consists of a radio access network (the eUTRAN) connecting users (or more precisely, user equipments) to access nodes acting as base stations, these access nodes in turn being linked to a core network. In eUTRAN terminology the access node is called an enhanced Node Basestation or eNB. A separate radio network controller (RNC) as used in previously-proposed systems is no longer required, with some of its functions being incorporated into the eNB, some into the Mobility Management Entity (MME), and some into the System Architecture Evolution GateWay (SAE GW). The eNBs connect to the core network which, in LTE, is referred to as the evolved packet core (EPC).

TR 36.912 “Feasibility Study for Further Enhancements for E-UTRA (LTE-Advanced) summaries the current agreed architecture for the use of Relays in LTE-A essentially as follows:

LTE-Advanced extends LTE Rel-8 with support for relaying as a tool to improve e.g. the coverage of high data rates, group mobility, temporary network deployment, the cell-edge throughput and/or to provide coverage in new areas.

The relay node is wirelessly connected to radio-access network via a donor cell. The connection can be
inband, in which case the network-to-relay link share the same band with direct network-to-UE links within the donor cell.
outband, in which case the network-to-relay link does not operate in the same band as direct network-to-UE links within the donor cell

At least “Type 1” relay nodes are supported by LTE-Advanced. A “type 1” relay node is an inband relaying node characterized by the following:
It controls cells, each of which appears to a UE as a separate cell distinct from the donor cell
The cells shall have their own Physical Cell ID (defined in LTE Rel-8) and transmit their own synchronization channels, reference symbols, . . . .
In the context of single-cell operation, the UE receives scheduling information and HARQ feedback directly from the relay node and sends its control channels (SR/CQI/ACK) to the relay node
This invention primarily relates to LTE-Advanced “type 1” (in-band) relay nodes as described above. The present invention relates to the problem of traffic multiplexing issue in the type 1 relay scenario and in equivalent situations for non-LTE systems (particularly if the network-to-relay links share the same band with direct network-to-UE links) for example such as systems operating under the WiMAX IEEE standard 802.16j). The invention specifically addresses how to identify the data packets (of the UEs served by the RN) delivered over the interface between the RN and its base station. This base station is known as the Donor eNB (DeNB) in LTE-A, because it gives up some of its radio resource (frequency bandwidth/time) to any relay node(s) it serves

### LTE Overview

In LTE-A, the interface between the relay node and the base station is known as the Un interface, and the interface between the UE and its serving relay node/base station is known as the Uu interface.

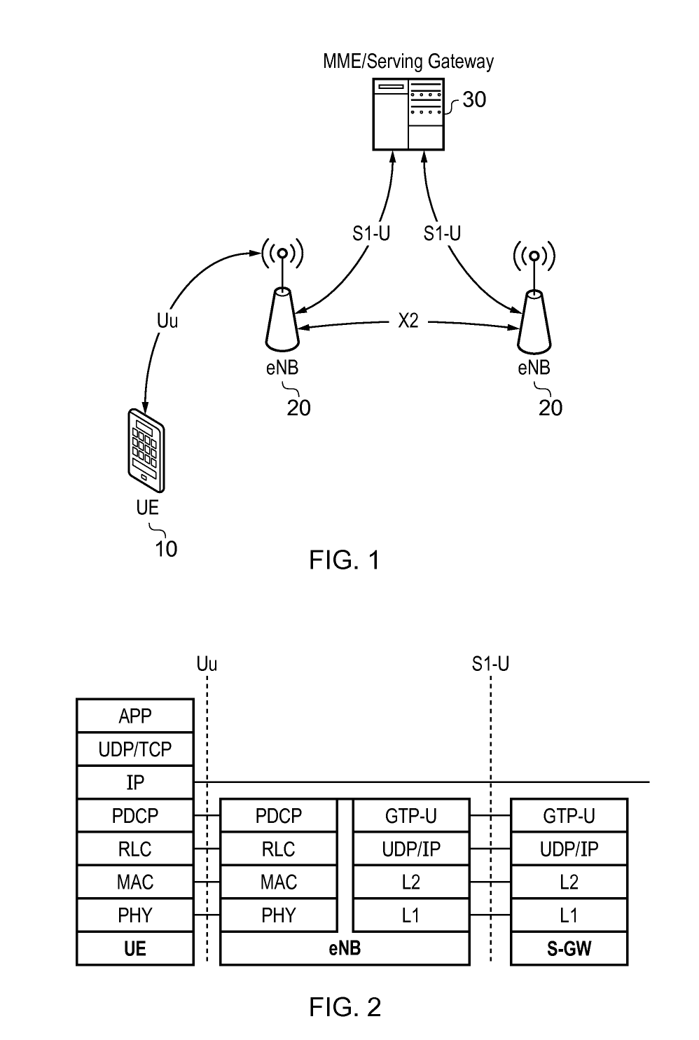

FIG. 1 illustrates the network topology between the user equipment 10, two enhanced Node Basestations 20, and the Serving GateWay 30 (SGW or S-GW). The Uu radio interface is marked, corresponding to the line marked ‘Uu’ in FIG. 1, likewise the S1-U interface marked on FIG. 1 corresponds to the lines marked ‘S1-U’ in FIG. 1. The user equipment 10 and first eNB 20 communicate over the Uu radio interface. The two eNBs 20 communicate with one another via a wired X2 interface or a non-wired logical connection

Over the two radio interfaces (Uu and Un), user data traffic is transported using the user plane. In LTE the user network protocol architecture consists of Packet Data Convergence Protocol (PDCP), Radio Link Control (RLC), Medium Access Control (MAC) and PHYsical (PHY) protocol layers.

FIG. 2 shows the relationship between the protocol layers for the LTE user plane. The combination of three sublayers; PDCP, RLC and MAC in the eNB and UE is known as Layer 2 (or L2), which is the layer above the physical layer (and below the IP layer in LTE) in the protocol stack.

The Packet Data Convergence Protocol (PDCP) is the top sublayer of the LTE user plane Layer 2 protocol stack, above the Radio Link Control (RLC) layer. The PDCP layer processes user plane packets, such as Internet Protocol (IP) packets, in the user plane. Depending on the radio bearer, the main functions of the PDCP layer are header compression, security (integrity protection and ciphering), and support for reordering and retransmission during handover.

The RLC layer controls the radio link using several modes: Transparent Mode (TM) has no RLC overhead and is used, for example, for broadcast SI messages; Unacknowledged Mode (UM) allows segmentation and concatenation of RLC SDUs (service data units), reordering of RLC PDUs (protocol data units), duplicate detection of RLC PDUs, and reassembly of RLC SDUs; and Acknowledged Mode (AM) gives the functionality of Unacknowledged Mode, with the additional functionality of retransmission of RLC Data PDUs, re-segmentation of retransmitted RLC Data PDUs, polling, status reporting and status prohibit.

The MAC layer provides for (de)multiplexing, HARQ (Hybrid Automatic Repeat-reQuest), random access, scheduling and discontinuous reception.

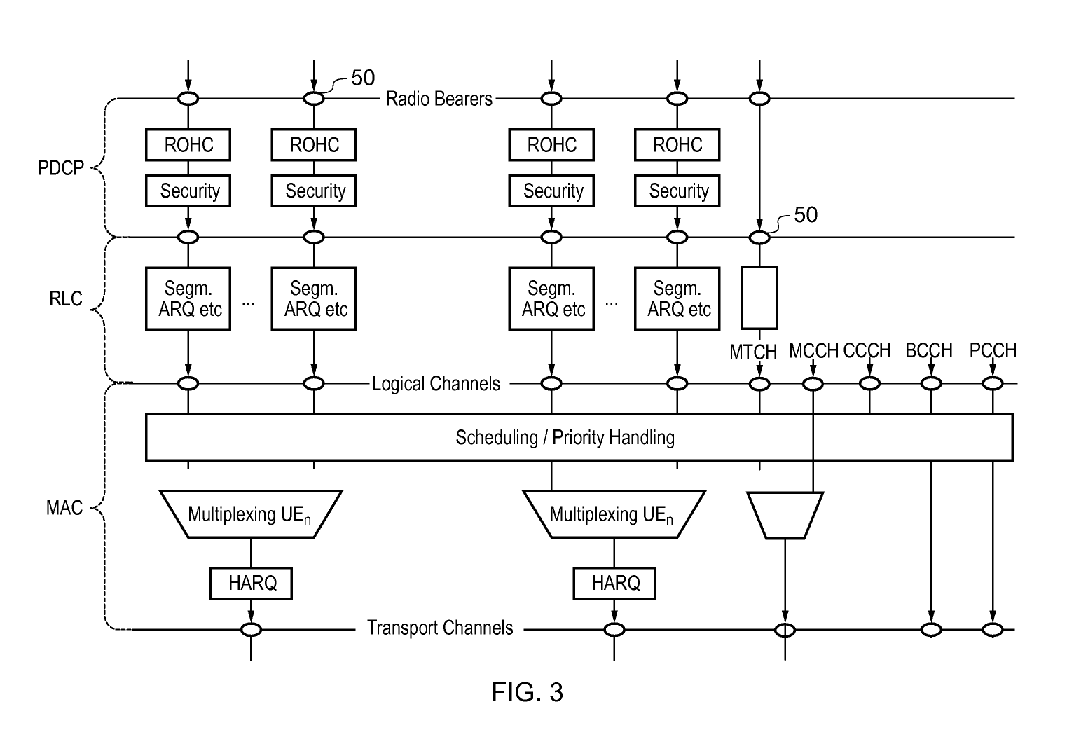

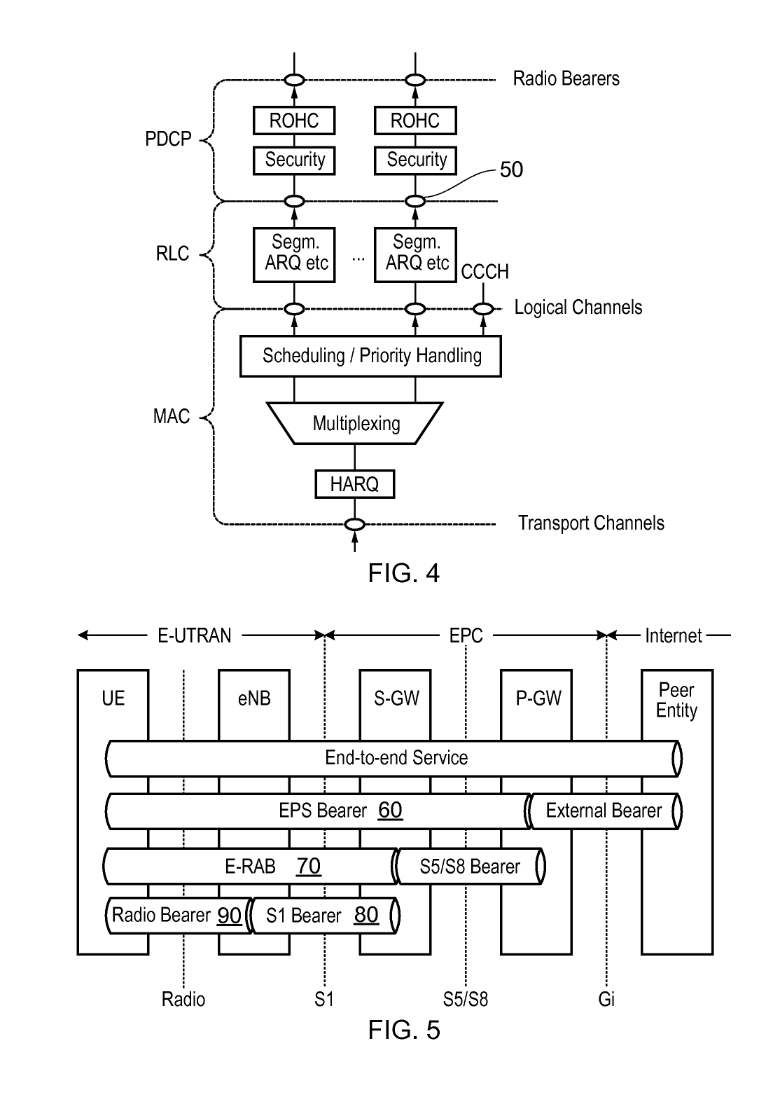

The sublayer structure for downlink and uplink communication is depicted in FIGS. 3 and 4.

Both figures show Service Access Points (SAP) marked with circles at the interfaces between sublayers. The SAPs 50 can be seen as a defined way of communicating between sublayers. The SAPs between the physical layer and the MAC sublayer provide the transport channels (containing data and system configuration between the UE and the eNB associated with the PHY layer). The SAPs between the MAC sublayer and the RLC sublayer provide the logical channels (additionally including system configuration between the UE and the eNB associated with the MAC layer).

In both uplink and downlink, only one transport block is generated per TTI (downlink or uplink subframe or frame) in the non-MIMO case. Thus all the logical channels must be sent in that transport block.

The multiplexing of several logical channels (which can be seen as data streams or (radio) bearers (RBs)), on the same transport channel (i.e. transport block) is performed by the MAC sublayer. A bearer or radio bearer is defined herein as a predefined data stream acting as a vessel for IP data between two endpoints, the data stream itself having a collection of defining parameters, such as quality of service (QoS), priority, allowable delay etc.

FIG. 5 illustrates the use of bearers in a conventional LTE/System Architecture Evolution (SAE) system. There is no relay node in this example. The interfaces between different network components or nodes are denoted by dashed lines. An Evolved Packet System (EPS) bearer 60 has to cross multiple interfaces, namely the S5/S8 interface from the Packet GateWay (P-GW) to the S-GW, the S1 interface from the S-GW to the eNodeB, and the radio interface (also known as the Uu interface) from the eNodeB to the UE. Across each interface, the EPS bearer is mapped onto a lower layer bearer, each with its own bearer identity. Each node must keep track of the binding between the bearer IDs across its different interfaces. For example, An S5/S8 bearer transports the packets of an EPS bearer between a P-GW and a S-GW. The S-GW stores a one-to-one mapping between an S1 bearer and an S5/S8 bearer. The bearer is identified by the GTP tunnel ID across both interfaces.

The end-to-end service is provided by an EPS bearer bound to an external bearer by the P-GW. The EPS bearer is provided by an S5/S8 bearer bound to an E-UTRAN Radio Access Bearer 70 (E-RAB) by the S-GW. In turn, the E-RAB is provided by an S1 bearer 80 bound to a radio bearer 90 by the eNodeB. The LTE architecture is used in this example to illustrate the concept of a bearer, but it should be understood that similar architectures exist in other communications standards or protocols.

### PDCP Sublayer

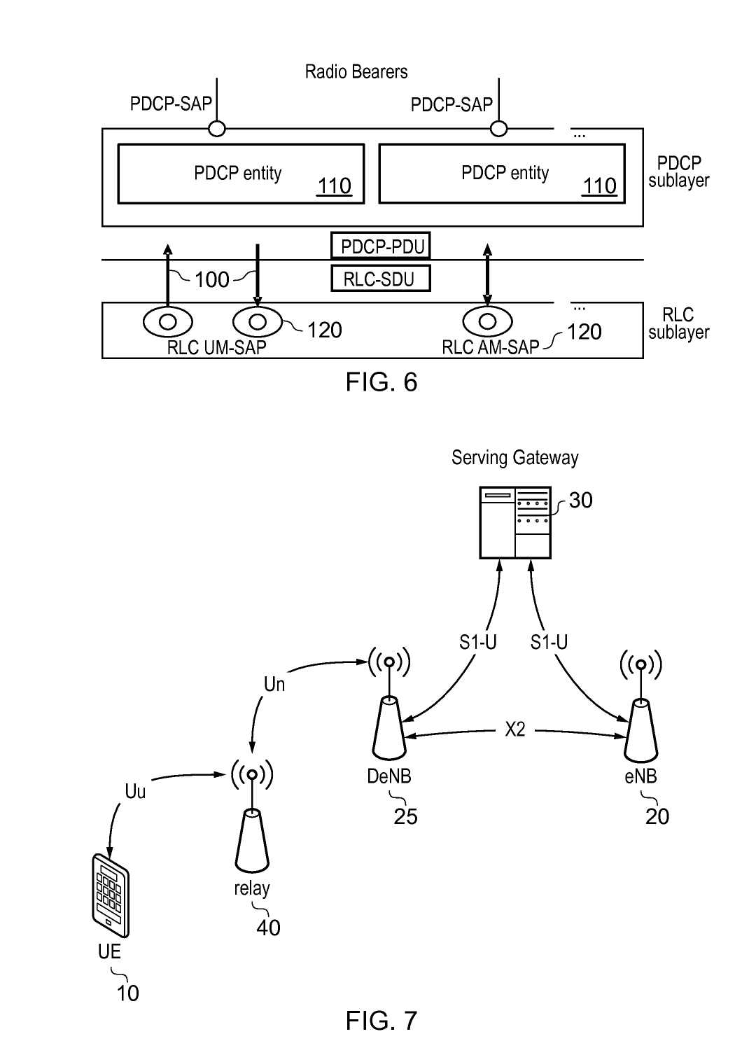

FIG. 6 represents one possible structure for the PDCP sublayer (or equivalent in an alternative protocol). Each RB 100 is associated with one PDCP entity 110 (or operational unit). Each PDCP entity is associated with one or two (one for each direction) RLC entities 120 depending on the RB characteristic (i.e. unidirectional or bi-directional) and RLC mode. The PDCP entities are located in the PDCP sublayer.

In FIG. 6 the right-hand PDCP entity has a unidirectional bearer with an acknowledgement mode and connects with a single RLC entity. The PDCP entity to the left has a bidirectional bearer, each direction in unacknowledged mode, one for downlink and one for uplink. It is associated with two RLC entities,

### Bearer Service

To realise a certain quality of service (QoS) a Bearer Service (service for data streams) with clearly defined characteristics and functionality is to be set up from the source to the destination of a service. An EPS (enhanced packet system) bearer/E-RAB is the most detailed level of control for bearer QoS control in the EPC/E-UTRAN.

Typically, multiple applications may be running in a UE at the same time, each one having different QoS requirements. For example, a user may be engaged in a VoIP (Voice over IP) call while at the same time browsing a web page or downloading a file using an FTP (File transfer Protocol) application. VoIP has more stringent requirements for QoS in terms of delay and delay jitter than web browsing and FTP, while the latter requires a much lower packet loss rate. In order to support multiple QoS requirements, different bearers are set up within the network architecture, each being associated with a set of QoS parameters, such as a QoS Class Identifier (QCI), and an Allocation and Retention Priority (ARP). Each QCI is characterized by priority, packet delay budget and acceptable packet loss rate. The QCI label for a bearer determines how it is handled in the eNodeB.

The ARP of a bearer is used for call admission control—i.e. to decide whether or not the requested bearer should be established in case of radio congestion. It also governs the prioritization of the bearer for pre-emption with respect to a new bearer establishment request. Once successfully established, a bearer's ARP does not have any impact on the bearer-level packet forwarding treatment (e.g. for scheduling and rate control). Such packet forwarding treatment should be solely determined by the other bearer level QoS parameters such as QCI.

The priority and packet delay budget (and to some extent the acceptable packet loss rate) from the QCI label determine the RLC mode configuration, and how the scheduler in the MAC handles packets sent over the bearer (e.g. in terms of scheduling policy, queue management policy and rate shaping policy). For example, a packet with a higher priority can be expected to be scheduled before a packet with lower priority. For bearers with a low acceptable loss rate, an Acknowledged Mode (AM) can be used within the RLC protocol layer to ensure that packets are delivered successfully across the radio interface.

### Relay Nodes in LTE/LTE-A

A typical LTE network with an additional RN is shown in FIG. 7. In this picture a UE 10 is connected to a RN 40 by the radio interface (Uu). The User Plane (UP) data for this UE is routed to a SGW 30. Typically the SGW is used for several eNBs which may be interconnected by the X2 interface, which may be a real physical connection between the eNBs or implemented as a logical connection via other network nodes. The DeNB 25 is the eNB that is connected to the RN using the radio interface (Un) which uses the same radio resources as the Uu radio interface. FIG. 8 shows two possible configurations for corresponding user plane network architecture. The upper configuration relates to a relay with the same protocol layers connecting it to the UE as to the rest of the communication system, which latter connection is exclusively via the eNB. In the lower configuration, the protocol layers are different. In the connection to the rest of the system, the upper protocol layers connect directly to the S-GW.

When RNs are used many UEs (maybe 400-500) will connect to the RN and have the appropriate radio bearers configured to support the individual users' applications. Therefore at the RN the traffic on the Un will be composed of many streams with different QoS requirements from different UEs served by the RN. These are expected to be multiplexed together in an efficient way.

In the Uu interface, an EPS bearer is one-to-one mapped to a data radio bearer (DRB), a DRB is one-to-one mapped to a Dedicated Traffic Channel (DTCH) logical channel, and all logical channels are many-to-one mapped to the Downlink or Uplink Shared Transport Channel (DL-SCH or UL-SCH). The maximum number of DRBs as well as DTCH logical channels per UE in Uu interface is limited to 8. Similarly, the maximum number of data radio bearers per RN may be limited over the Un interface, which forces the RN to utilise the limited DRBs or DTCH logical channels to transport packets of all EPS bearers of the served UEs at the Un interface.

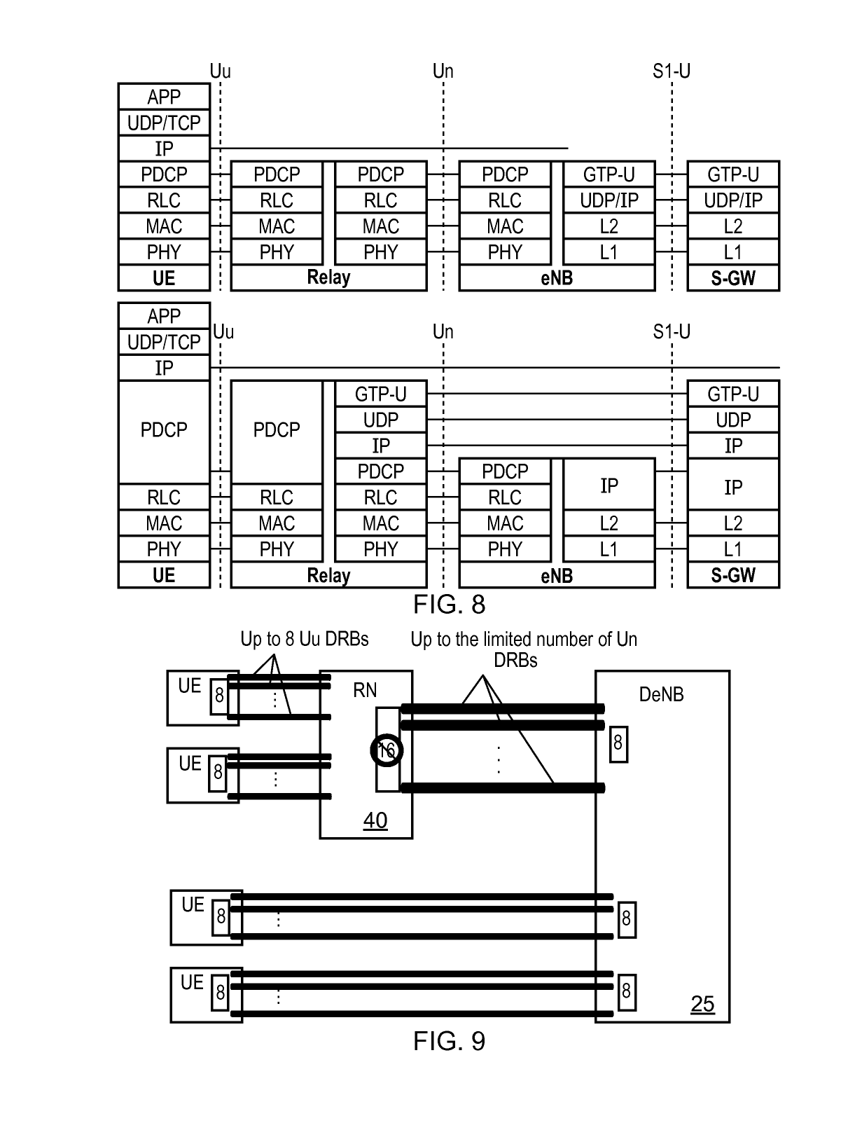

As an example, FIG. 9 illustrates the mapping issue in the Un interface. It is assumed that the maximum number of DRBs per RN 40 over Un is 8. Assuming as a simplistic example that each RN serves 2 UEs and each UE establishes 8 EPS bearers, the total number of EPS bearers flowing through RN is 16, which is twice as many as the maximum number of DRBs per RN. Thus the EPS bearers from the UEs need to be grouped for transmission across the Un interface. Grouping data streams from different UEs requires identification of each data stream within the group.

According to embodiments of a first aspect of the invention there is provided a transmission method in a communication system comprising a base station, a relay node and a plurality of UEs, the method comprising, when a new user data stream is established between a UE and the relay node, sending data stream characteristics including quality of service requirements, a channel identification and a UE identification for the user data stream to the base station; and for transmission between the relay node and the base station, grouping the user data stream into one of a plurality of groups of multiplexed user data streams, each of which is defined by the quality of service requirements; wherein the user data stream is distinguished within its group on receipt using multiplexing information held within the group in conjunction with the data stream characteristics.

Thus embodiments of the invention allow pre-transmitted characteristics to be used to identify a data stream (or bearer) when it is received, thus lowering signaling overhead for ongoing transmission of user data.

The data stream may be for uplink transmission (from the UE to the RN to the base station), downlink transmission (from the base station to the RN to the UE), or for bi-directional transmission. In any of these cases, the base station can use the data stream characteristics, either to multiplex data streams from different UEs (downlink) or to demultiplex these data streams (uplink) or both. The data stream characteristics will of course already be available at the relay end, which is at one end of the relevant part of the transmission path. Further parameters may be included within the data stream characteristics beyond those already specified, for example Layer 2 parameters of the data stream.

The skilled reader will appreciate that the UE can be any fixed or mobile user equipment, such as a hand-held device (PDA, telephone etc), a laptop or a fixed telephone or computer.

The communications system may be suitable to operate according to the LTE-Advanced communications protocol or any other communications protocol. In the case of the LTE-Advanced protocol, the base station is an eNB access node known as a donor eNB. As a further alternative, it may be that the communications system is operating in a mixed network including LTE eNBS and LTE-A eNBs.

The multiplexing information can be any that distinguishes the different data streams in the group (usually from different UEs) when used in combination with the pre-transmitted data stream characteristics. In one alternative, the multiplexing information may be a UE identifier for each UE in the group.

Here, the UE identifier may be shorter than the full identifier often used. For example the C-RNTI (Cell Radio Network Temporary Identifier) may be compressed, preferably by rationalising the number of bits used, to reflect only the bits needed to represent active UEs in the cell provided by the RN. The same rationalised form of the C-RNTI may also be sent as one of the data stream characteristics, instead of the full C-RNTI.

In another alternative, the multiplexing information comprises the position of the user data stream within its group of multiplexed user data streams. This is a bit-map approach and in many circumstances requires the order of the user data streams in the group to be sent to the base station at the same stage as the new data stream characteristics, that is whenever a new data stream joins the group (and also when there are updated, as detailed further below).

Advantageously, each group of multiplexed user data streams carries data relating to more than one UE. Thus the groups are made according to QoS characteristics, rather than UE.

Preferably, the UE identifier (whether pretransmitted or transmitted with individual data packets as multiplexing information) and channel identification are used to identify and thereafter thus to allow demultiplexing of the user data stream. This demultiplexing occurs at the base station for uplink transmission, or at the relay node for downlink transmission. Use of the channel ID (or more specifically of the Logical Channel ID in LTE) allows distinction between different data streams from the same UE.

In many configurations, a plurality of user data streams with different quality of service requirements is provided between the UE and the relay node. In such a case, any data stream with a particular level of QoS, such as a particular QCI is multiplexed into a group at the base station/RN which is different from a group used for a bearers with a different level of QoS, even if this bearer relates to the same UE.

Preferably the data stream is labelled on each packet in the data stream. Thus advantageously, the channel identification and/or UE identification are used to recognise the individual packets. The channel identification may be in any suitable form, such as a logical channel ID in LTE-A.

The data stream characteristics are preferably determined specifically for transmission between the UE and the relay node, and are used to set up transmission between the relay node and the base station. They may also be used for scheduling purposes between the UE and the relay node and/or between the relay node and the base station.

The channel identification and UE identification are preferably provided in the layer above the physical layer in the relay node, preferably in the PDCP sublayer in an LTE system.

The data stream characteristics are sent to the base station when a data stream is initialized. However preferably they may be updated and re-sent to the base station periodically, and/or whenever there is a change in data stream requirements. For example, if local conditions or changed mobility of the UE leads to a different QCI becoming suitable, an update will be sent to the base station with at least an updated QCI.

In an embodiment of a further aspect of the invention there is provided a communication system comprising a base station, a relay node and a plurality of UEs, wherein the relay node is operable, when a new user data stream is established between a UE and the relay node, to send data stream characteristics including quality of service requirements, a channel identification and a UE identification for the user data stream to the base station; the relay node is operable for uplink transmission from the relay node to the base station and/or the base station is operable for downlink transmission from the base station to the relay node, to group the user data stream into one of a plurality of groups of multiplexed user data streams, each of which is defined by the quality of service requirements; and wherein the base station is operable for uplink transmission and/or the relay node is operable for downlink transmission to distinguish the user data stream within its group using multiplexing information held within the group in conjunction with the pre-transmitted data stream characteristics.

This aspect of the invention relates to the communication system carrying the method as previously described. The communication system may carry out the method on the downlink, on the uplink or both, depending on the system configuration.

In an embodiment of a still further aspect of the invention there is provided a relay node in a communication system comprising a base station, the relay node and a plurality of UEs, wherein the relay node is operable, when a new user data stream is established between a UE and the relay node, to send data stream characteristics including quality of service requirements, a channel identification and a UE identification for the user data stream to the base station; the relay node is operable for uplink transmission from the relay node to the base station, to group the user data stream into one of a plurality of groups of multiplexed user data streams, each of which groups is defined by the quality of service requirements; and/or the relay node is operable for downlink transmission to receive groups of multiplexed data streams from the base station, each of which groups is defined by the quality of service requirements; and wherein the relay node is operable for uplink transmission to provide multiplexing information within the group to allow the user data stream to be distinguished within the group in conjunction with the data stream characteristics and/or the relay node is operable for downlink transmission to distinguish the user data stream within its group using multiplexing information held within the group in conjunction with the data stream characteristics.

This aspect of the invention refers to the role carried out by the relay node, on the downlink, on the uplink, or both. The aspect also extends to the corresponding method which is carried out by the relay node and to a computer program which when executed carries out that method or which when downloaded onto a computing device of a relay node causes it to become the relay node as claimed.

In an embodiment of a further aspect of the invention there is provided a base station in a communication system comprising the base station, a relay node and a plurality of UEs, wherein the base station is operable, when a new user data stream is established between a UE and the relay node, to receive data stream characteristics including quality of service requirements, a channel identification and a UE identification for the user data stream from the relay node; the base station is operable for downlink transmission from the base station to the relay node, to group the user data stream into one of a plurality of groups of multiplexed user data streams, each of which groups is defined by the quality of service requirements; and/or the base station is operable for uplink transmission to receive groups of multiplexed data streams from the relay node, each of which groups is defined by the quality of service requirements; and wherein the base station is operable for downlink transmission to provide multiplexing information within the group to allow the user data stream to be distinguished within the group in conjunction with the data stream characteristics and/or the base station is operable for uplink transmission to distinguish the user data stream within its group using multiplexing information held within the group in conjunction with the data stream characteristics.

This aspect of the invention refers to the role carried out by the base station, on the downlink, on the uplink, or both. The aspect also extends to the corresponding method which is carried out by the base station and to a computer program which when executed carries out that method or which when downloaded onto a computing device of a base station causes it to become the base station as claimed.

Embodiments of a yet further aspect of the invention provide software, which when executed on a computing device of the base station and a computing device of the relay node carries out the method of an embodiment of the first aspect, or which when downloaded onto a relay node and a base station cause them to become the relay node and base station of the communication system as described above.

The software may be in the form of a computer program, for example as computer program stored on a computer-readable medium or in a signal downloaded from the internet or elsewhere. It may also be in the form of a suite of computer program modules, where overall combined functionality is provided by separate software modules on a relay and a base station.

The features and sub-features of the first aspect set out in detail above apply to each of the further aspects unless specifically incompatible and features of any and all the aspects may be freely combined.

Features of the prior art and preferred features of the present invention will now be described, purely by way of example, with reference to the accompanying drawings, in which:—

FIG. 1 shows a simple network architecture for LTE;

FIG. 2 shows the relationship between protocol layers for LTE;

FIG. 3 shows a Layer 2 structure for downlink;

FIG. 4 shows a Layer 2 structure for uplink;

FIG. 5 is a schematic representation of radio bearers in an LTE system;

FIG. 6 shows a PDCP layer structure view;

FIG. 7 shows an LTE/LTE-A architecture with relays;

FIG. 8 shows two possibilities for the relationship between protocol layers for LTE using relays;

FIG. 9 is a schematic diagram showing bearer mapping issues between the Un interface and the Un interface;

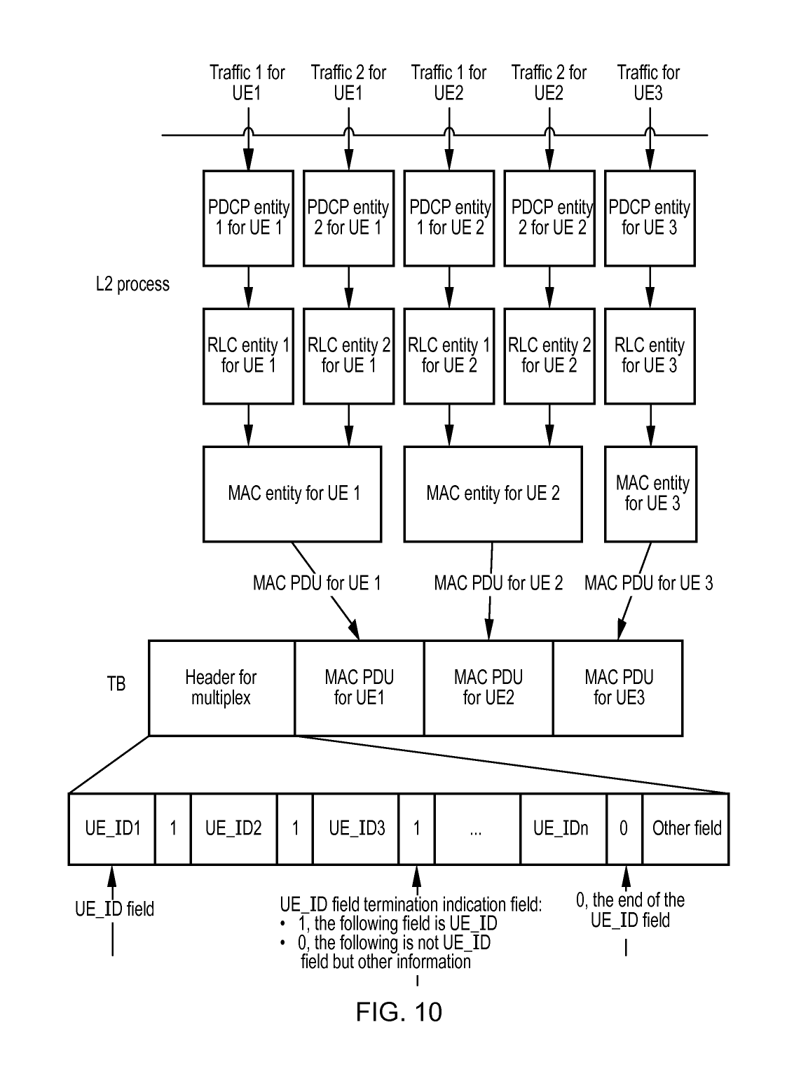

FIG. 10 shows a possible Layer 2 process for data packet identification in the prior art;

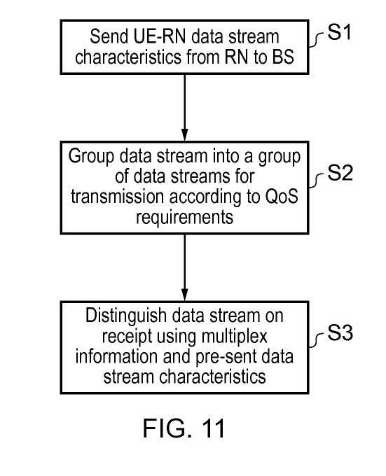

FIG. 11 is a flowchart depicting a general embodiment of the invention;

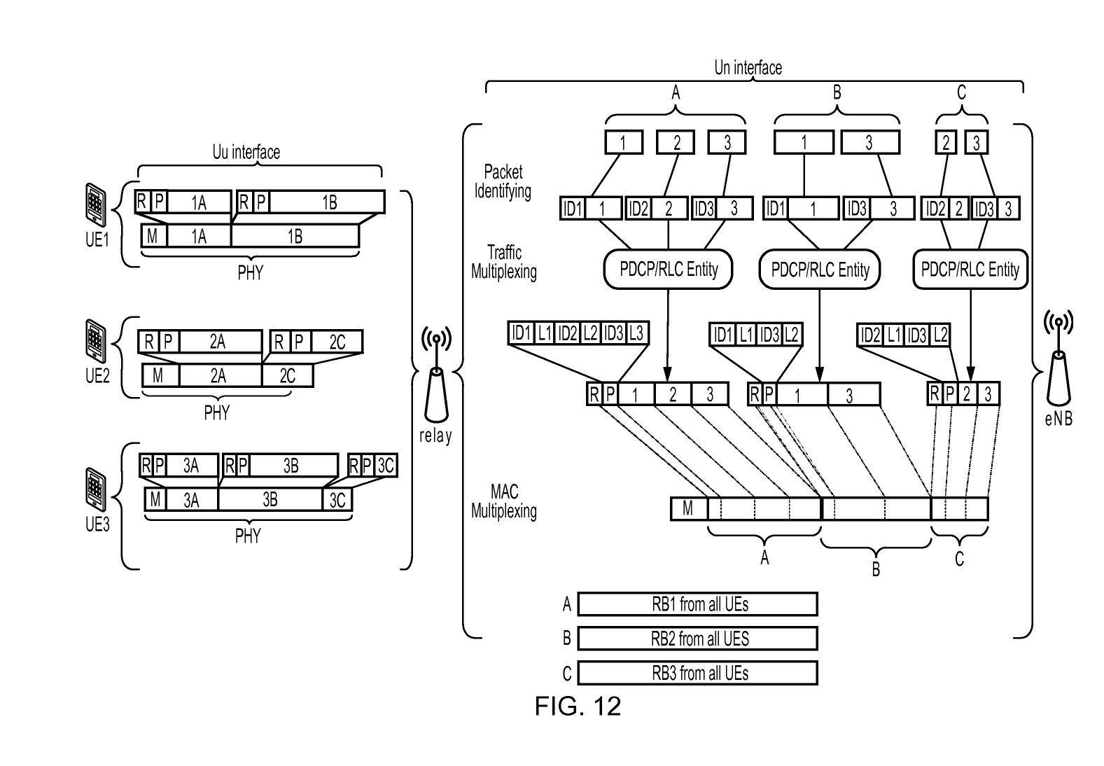

FIG. 12 shows uplink traffic multiplexing and labelling over the Un interface;

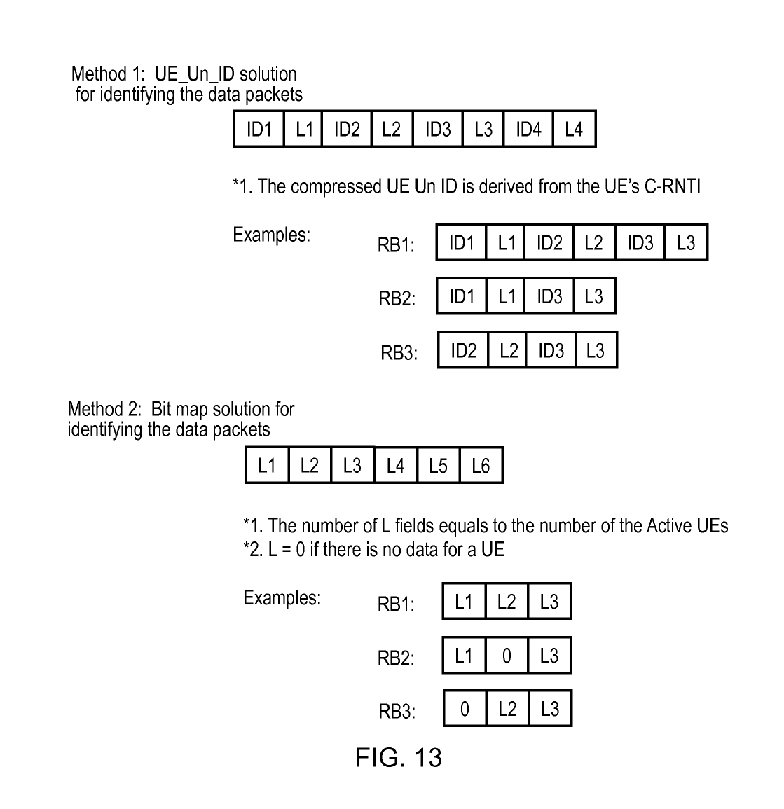

FIG. 13 shows in schematic form two ways of identifying packets in a data stream;

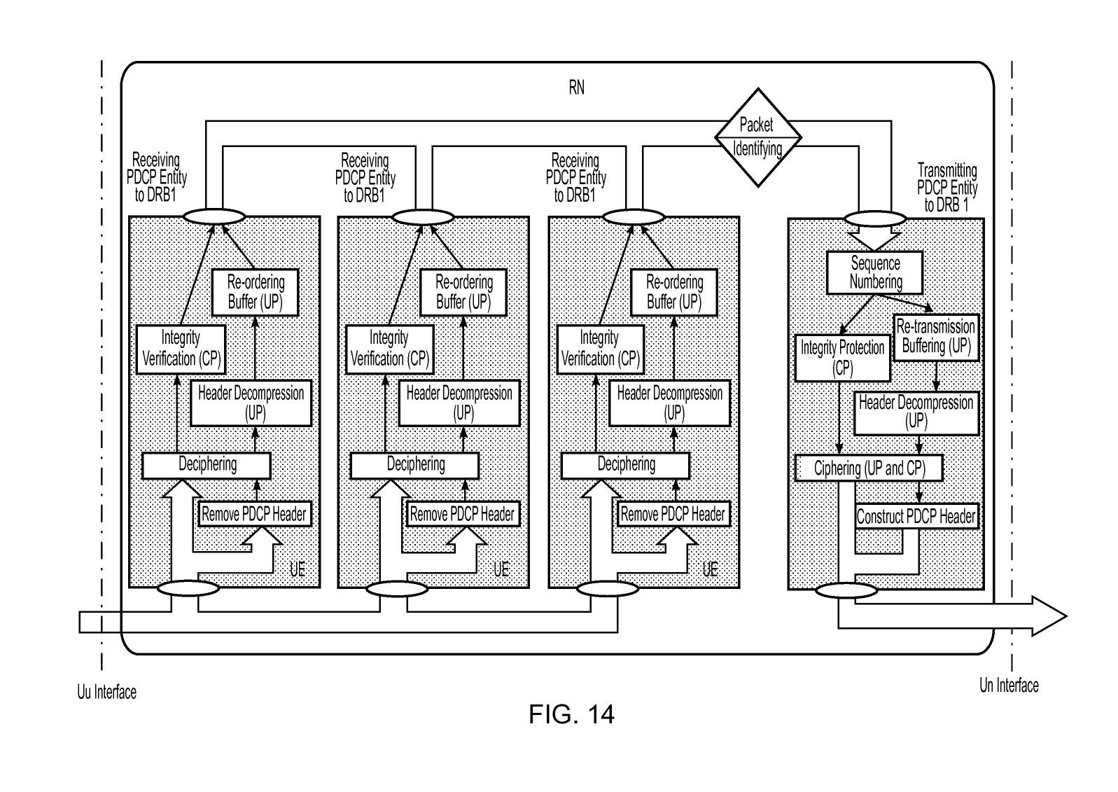

FIG. 14 shows an example of uplink traffic multiplexing over the Un interface; and

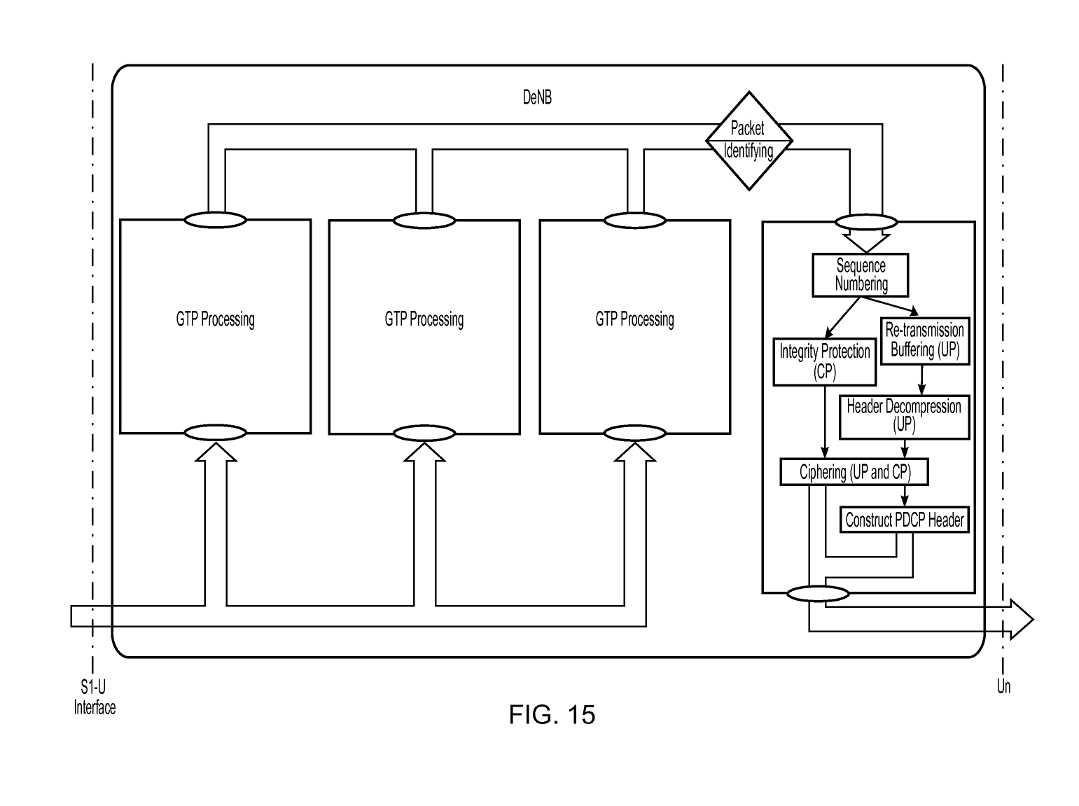

FIG. 15 shows an example of downlink traffic multiplexing over the Un interface.

Previous solutions to the specific issue of identifying multiplexed data streams between an RN and a BS are available.

In prior art document R2-094343 (TSG-RAN WG2#67, LA, US Jun.-3 Jul. 2009) the traffic (data stream) multiplexing issue for type I relay operated scenario is discussed. This document proposes to perform multiplexing on the L2 for different UEs' traffic. Two possible choices can be taken to separate this multiplexed traffic for each UE on the RN side:
Choice 1: implicit solution where each data steam is identified by Logical channel identification
Choice 2: explicit solution where extra field is defined in the MAC PDU to separate traffic for different UE.

For choice 1, each data stream is mapped to one logical channel. The LCID is used to identify all these packets multiplexed on the same MAC PDU. The benefits for this choice is that it reuses the current LTE defined L2 structure. But since 4 bits are used for the LCID in LTE only up to 16 data streams can be identified. This choice will put strict a limit on the RN application scenario where the supported UEs' traffics should be no more than 16.

For choice 2, there is no change to the current LTE defined LCID length but one extra header is added in the MAC PDU, which includes the UE ID to differentiate each data stream and the possible L2 structure is shown in FIG. 10.

In R2-094343 there are 3 options for UE_ID definition to optimize the MAC PDU header overhead
C-RNTI is used for this purpose which means 16 bit is added for each UE.
Fixed length UE_ID is adopted according to the maximum permitted UE number served by the same RN
Variable length UE_ID according to the served UE number by the same RN.

Similarly, R2-094811 (3GPP TSG-RAN Meeting#67, Shenzen, China, August 24-Aug. 28, 2009) proposes that PDCP protocol is used to differentiate UEs' bearers mapped to the same DRB on the Un interface by adding the UE RB ID into the PDCP header.

FIG. 11 shows a general embodiment of the invention. Firstly, in step S1, user data stream characteristics of a new data stream between the UE and the RN are sent to the BS (by the RN). Then in step S2 the data stream is grouped into a group of multiplexed data streams for transmission between the RN and the BS, including multiplexing information. The grouping is by quality of service requirements. As the data stream arrives, it can be distinguished from the other data streams in the same group using the pre-sent data stream characteristics and the multiplexing information.

The multiplexing information is advantageously provided for each packet of the data stream, for example as part of a Layer 2 header. Some LTE embodiments of the invention propose that the combination of the compressed UE Un ID and the Logical Channel ID can be used to identify (recognise or distinguish) the data packets at PDCP layer, which are delivered at both uplink and downlink over Un interface. A compressed UE Un ID may be used and is derived from the C-RNTI of UEs that are connected and served by the RN.

The information exchanged can enable the cooperative resource allocation for both the Uu interface controlled by the RN scheduler and Un interface by DeNB. The information of the compressed UE Un ID (so-called because it is used in the Un and because it reflects only the active UEs in the RN cell) and the associated Logical Channel ID are communicated from the RN to the DeNB. The information is first sent to the DeNB when the RN establishes the Uu data radio bearer for the UE, then only the updates of the information need to be sent to the DeNB, thus ensuring that only the minimum overhead is required in order to identify the PDCP data packets on Un interface.

There are several important practical implementation points for some invention embodiments, as follows:
1. The combination of the compressed UE Un ID and the Logical Channel ID can be used to identify the data packets at PDCP layer. This information is communicated from the RN to the DeNB.
2. When the RN establishes a Uu data radio bearer for a UE, the related information (e.g. the allocated C-RNTI of the UE, the QCI parameters and Layer 2 parameters of the allocated data radio bearer) is signalled to the DeNB. Then only the updates of the information need to be sent to the DeNB, thus ensuring that only the minimum overhead is required in order to identify the PDCP data packets on the Un interface.
3. The DeNB uses this information to set up or update the appropriate Un bearers for both UL and DL, as well as adjust the scheduling information. Thus the cooperative scheduling between the schedulers for both Uu and Un interfaces is enabled, and the QoS guarantee for the UEs connected to the RN can be achieved.
4. Two methods (as set out in more detail below) that may be used to identify the packets are proposed to add the multiplexing information into the PDCP PDU header.

FIG. 12 shows packets for 3 UEs, which are transmitted over the Uu interface and then over the Un interface. At the left hand side of the diagram, the packets are shown in two rows, to demonstrate the view in different layers. Here, “M” refers to the MAC header on the lower row, and “R” and “P” to the headers in the RLC layer and PDCP layer. There are three different QoS levels represented as A, B and C. Looking at the Uu interface, UE1 produces two different streams, one with QoS level A, and one with QoS level B. UE2 has a stream of QoS level A and one of QoS level C. UE3 has a stream of QoS level A, a stream of QoS level B and a stream of QoS level C.

For the Un interface, the streams with the same QoS level are multiplexed together by the RN on the uplink. First the packets from the different UEs are identified (ID1, ID2, ID3) and then for each QoS level, a PDCP/RLC entity processes the streams, to give a single multiplexed group. The overall header for each group A, B and C is shown here with the UE ID and the “I” field denoting a number of bits for that UE. MAC multiplexing then puts the groups together for transmission.

As shown in FIG. 12, multiple data radio bearers over the Uu interface are allocated to multiple UEs that are connected to the RN, each DRB (data radio bearer) being associated with certain QCI parameter and Layer 2 parameters (e.g. RLC mode, etc.). The Uu DRBs associated with particular parameters are associated with the Un DRBs with the same particular parameters by the RN for UL data delivery and the DeNB for DL data delivery. Within one Un DRB, the compressed UE Un ID may be added into the PDCP PDU header to identify the packets belonging to different UEs.

The compressed UE Un ID is derived from the C-RNTI of UEs that are connected and served by the RN. The information of the compressed UE Un ID and the associated Logical Channel ID are first communicated from the RN to the DeNB. That is, when the RN establishes a Uu data radio bearer for a UE, the related information (e.g. the allocated C-RNTI of the UE, the QCI parameters and Layer 2 parameters of the allocated data radio bearer) is signalled to the DeNB. Then only the updates of the information need to be sent to the DeNB, thus ensuring that only minimum overhead is required in order to identify the PDCP data packets on the Un interface. The DeNB uses this information to set up or update the appropriate Un bearers for both UL and DL, as well as adjust the scheduling information. Thus cooperative scheduling between the schedulers for both Uu and Un interfaces is enabled, and the QoS guarantee for the UEs connected to the RN can be achieved.

FIG. 13 shows two methods to identify the packets by adding the multiplexing information into the PDCP PDU header. In one alternative, the UE identifier is used in the PDCP packet header of each packet, followed by an “L” field to define how many bits follow. This alternative is the one shown in FIG. 12. In a practical implementation, the UE identifier and the L field may be in either order, depending on the system design preferences.

As a second alternative, the L fields for each UE always follow a predetermined order according to the active UEs and the number of UEs equals the number of L fields if there is one data stream per UE in the group, or there may be more L fields than UEs if more than one data stream is provided to/from at least one UE. This is a bit map approach, and the L fields do not require identification using a UE identifier. In this second approach, the L field takes the value 0 if there is no data for a UE.

One procedure for the allocation of radio resources for both Uu and Un is as follows:
1. When the RN establishes a Uu data radio bearer for a UE, the related information (e.g. the allocated C-RNTI of the UE, the QCI parameters and Layer 2 parameters of the allocated data radio bearer), including the compressed UE Un ID, is communicated to the DeNB.
2. Based on this information, the DeNB sets up or updates the Un bearers with the similar parameter for both UL and DL accordingly.
3. Only the updates of the information need to be sent to the DeNB, thus ensure that only the minimum overhead is required in order to identify the PDCP data packets on Un interface.
4. The combination of the compressed UE Un ID and the Logical Channel ID are used to identify the data packets at PDCP layer over Un interface.

FIG. 14 depicts an example of the proposed traffic multiplexing and packet identifying mechanism on the uplink in the PDCP layer. The example assumes that three UEs connected to the RN are in Active Mode, and that each of them has been allocated data radio bearers. DRB1s of each of the UEs are those with the same features, such as the QCI parameters and Layer 2 parameters (e.g. RLC Mode). Only DRB1 is shown, but the skilled reader will appreciate that one or more of the UEs may have further DRBs, DRB2 etc, which are not depicted.

Based on the mechanism of invention embodiments, the DeNB allocates data radio bearers for UL and DL over the Un interface with the same or similar features, as shown in FIG. 14 (DRB1 for UL in Un).

Data packets from the UEs over the Uu interface are received and processed separately in the RN's Receiving PDCP Entities associated with DRB1. The packets are further identified by being associated with the appropriate UE_Un_ID before they pass to the Transmitting PDCP Entity for DRB1. Then the packets are processed in the Transmitting PDCP Entity, and the PDCP Header including the multiplexing Header described above is constructed for each PDCP PDU.

FIG. 15 is an equivalent figure for multiplexing downlink transmission. The figure therefore shows processing in the PDCP layer of the DeNB. The S1-U interface to the S-GW is shown on the left and the Un interface to the RN is shown on the right. Data from the S-GW undergoes GTP (GPRS tunnelling protocol) processing in three separate strands/entities for one UE, removing appropriate headers from the incoming data streams. The packets are identified with the UE identifier, or using the bitmap approach and then multiplexed together in a PDCP transmitting entity.

### Summary of Some Preferred Features

LTE embodiments of the invention propose that the combination of the compressed UE Un ID and the Logical Channel ID can be used to identify the data packets at a PDCP layer, which are to be delivered at both Uplink and Downlink over the Un interface. The compressed UE Un ID may be derived from the C-RNTI of UEs that are connected and served by the RN. The hierarchical packet labelling/transmission scheme is also proposed to enable the resource allocation of both the Uu interface controlled by RN scheduler and the Un interface by the DeNB. The compressed UE Un ID and the associated Logical Channel ID may be communicated from the RN to the DeNB. The information is first sent to the DeNB when the RN establishes the Uu data radio bearer for the UE, then only the updates of the information need to be sent to the DeNB, thus ensuring that only the minimum overhead is required in order to identify the PDCP data packets on the Un interface.

What is claimed is:

1. A transmission method in a communication system comprising a base station, a relay node and a plurality of UEs, the method comprising:
when a new user data stream is established between a UE and the relay node, sending data stream characteristics including quality of service requirements, a channel identification and a UE identification for the user data stream to the base station;
for transmission between the relay node and the base station, grouping the user data stream into one of a plurality of groups of multiplexed user data streams, each of which groups is defined by quality of service requirements; wherein
the user data stream can be distinguished within its group on receipt using multiplexing information held within the group in conjunction with the data stream characteristics.

2. A method according to claim 1, wherein the user data stream is for uplink transmission, downlink transmission, or bi-directional transmission.

3. A method according to claim 1, wherein the multiplexing information is a UE identifier for each UE in the group.

4. A method according to claim 3, wherein the UE identifier is compressed when used as multiplexing information, preferably by rationalising the number of bits used, to reflect only the bits needed to represent active UEs.

5. A method according to claim 3, wherein the multiplexing information comprises the position of the user data stream within its group of multiplexed user data streams.

6. A method according to claim 3, wherein each group of multiplexed user data streams carries data relating to more than one UE.

7. A method according to claim 3, wherein the UE identifier and channel identification are used to distinguish and demultiplex the user data stream at the base station for uplink transmission, or at the relay node for downlink transmission.

8. A method according to claim 3, wherein a plurality of user data streams with different quality of service requirements is provided between the UE, the relay node and the base station, and preferably wherein the channel identification and UE identification are used to recognise the packets.

9. A method according to claim 1, wherein the channel identification and UE identification are provided in the layer above the physical layer in the relay node, preferably in the PDCP sublayer in an LTE system.

10. A method according to claim 1, wherein the data stream characteristics are those determined for transmission between the UE and the relay node, and are used by the base station to set up transmission between the relay node and the base station.

11. A method according to claim 1, wherein the data stream characteristics are those determined for transmission between the UE and the relay node, and are used by the base station for scheduling purposes between the UE and the relay node and/or between the relay node and the base station.

12. A method according to claim 1, wherein the data stream characteristics are updated and re-sent to the base station periodically, and/or whenever there is a change in data stream requirements.

13. A communication system comprising a base station, a relay node and a plurality of UEs, wherein:
the relay node is operable, when a new user data stream is established between a UE and the relay node, to send data stream characteristics including quality of service requirements, a channel identification and a UE identification for the user data stream to the base station;
the relay node is operable for uplink transmission from the relay node to the base station and/or the base station is operable for downlink transmission from the base station to the relay node, to group the user data stream into one of a plurality of groups of multiplexed user data streams, each of which is defined by the quality of service requirements; and wherein
the base station is operable for uplink transmission and/or the relay node is operable for downlink transmission to distinguish the user data stream within its group using multiplexing information held within the group in conjunction with the data stream characteristics.

14. A relay node in a communication system comprising a base station, the relay node and a plurality of UEs, wherein:
the relay node is operable, when a new user data stream is established between a UE and the relay node, to send data stream characteristics including quality of service requirements, a channel identification and a UE identification for the user data stream to the base station;
the relay node is operable for uplink transmission from the relay node to the base station, to group the user data stream into one of a plurality of groups of multiplexed user data streams, each of which groups is defined by the quality of service requirements; and/or the relay node is operable for downlink transmission to receive groups of multiplexed data streams from the base station, each of which groups is defined by the quality of service requirements; and wherein
the relay node is operable for uplink transmission to provide multiplexing information within the group to allow the user data stream to be distinguished within the group in conjunction with the data stream characteristics and/or the relay node is operable for downlink transmission to distinguish the user data stream within its group using multiplexing information held within the group in conjunction with the data stream characteristics.

15. A base station in a communication system comprising the base station, a relay node and a plurality of UEs, wherein:
the base station is operable, when a new user data stream is established between a UE and the relay node, to receive data stream characteristics including quality of service requirements, a channel identification and a UE identification for the user data stream from the relay node;
the base station is operable for downlink transmission from the base station to the relay node, to group the user data stream into one of a plurality of groups of multiplexed user data streams, each of which groups is defined by the quality of service requirements; and/or the base station is operable for uplink transmission to receive groups of multiplexed data streams from the relay node, each of which groups is defined by the quality of service requirements; and wherein
the base station is operable for downlink transmission to provide multiplexing information within the group to allow the user data stream to be distinguished within the group in conjunction with the data stream characteristics and/or the base station is operable for uplink transmission to distinguish the user data stream within its group using multiplexing information held within the group in conjunction with the data stream characteristics.
